(19) United States
(12) Patent Application Publication
(10) Pub. No.: US 2020/0216718 A1
(43) Pub. Date: Jul. 9, 2020

(54) CORROSION PREVENTION TAPE

(71) Applicant: Composite Corrosion Prevention Limited, London, Greater London (GB)

(72) Inventor: Robert Stephen ROPER, London, Greater London (GB)

(73) Assignee: Composite Corrosion Prevention Limited, London, Greater London (GB)

(21) Appl. No.: 16/628,312

(22) PCT Filed: Jul. 4, 2018
(86) PCT No.: PCT/GB2018/051878

§ 371 Date: Jan. 3, 2020

(30) Foreign Application Priority Data
Jul. 5, 2017 (GB) 1710804.4

(51) Int. Cl. C09J 7/24; F16L 58/04; C23F 13/02; C09J 7/38; C09J 7/40; C09J 11/08; C09J 11/04; F16L 58/16

(52) U.S. Cl. CPC C09J 7/245; F16L 58/04; C23F 13/02; C09J 7/381; C09J 7/40; C08L 2203/18; C09J 11/04; F16L 58/16; C09J 2427/006; C09J 2203/30; C09J 11/08

(57) ABSTRACT

The present invention relates to a corrosion prevention tape for wrapping an irregular pipe section, the tape comprising:
(i) an adhesive component, the adhesive component comprising:
   from 10 to 50 wt % functionally modified elastomer, and
   from 0.1 to 20 wt % discrete reinforcing strands dispersed within the adhesive component; and
(ii) a backing layer for the adhesive component.

### FIELD OF INVENTION

The present invention relates to a corrosion prevention tape. It relates also to a corrosion protected article, and to a method of protecting a substrate against corrosion.

### BACKGROUND OF THE INVENTION

Many corrosion prevention tapes are commercially available. In use, such tapes are wrapped around (preferably un-primed) steel pipe sections to prevent corrosion of the structure during its service life. Ideally, these tapes are suitable for use with irregular steel pipe sections, such as flanges, valves, elbows, tee-joints etc. Many materials and constructions have been developed to suit the wide range of service conditions under which the pipes operate. Condition variables include operating temperature, ambient temperature, above or below ground installations and exposure to corrosion promoting environments, such as salt water.

Tapes currently available have adhesive components that are made from a wide variety of materials, such as bitumen, petrolatum, butyl rubber and polyisobutylene. Typically, the adhesive component of the tape is soft and conformable, allowing thorough surface wetting and penetration into the micro imperfections of the substrate to which the tape is applied, typically a steel. Steel adhesion is vital not only to prevent the tape becoming dislodged during service, but also to prevent the ingress of moisture at the tape/steel interface. The soft, tacky, active adhesive component is supported on a reinforcing carrier, which provides strength both to facilitate application of the tape and to the adhesive component mechanically. A covering is commonly included, such that the soft, adhesive component, complete with its reinforcing carrier, is coated as an inner layer onto a suitable flexible plastics covering or film, allowing easy manual wrapping of the substrate such as a steel pipe. Typically, only the plastics film is visible after wrapping. The adhesive component, coated with the plastics ply, is commonly called the ‘inner-wrap’. The inner-wrap lacks mechanical strength and would be quickly damaged during installation, for example, if the structure were buried, or during service. The inner wrap is therefore commonly protected by a pressure sensitive adhesive (PSA) coated outer plastic film over-wrapping (the ‘outer wrap’), to impart the essential mechanical protection and also to enhance the corrosion resistance of the corrosion protection system provided by the corrosion prevention tape. Both inner and outer wraps can be applied with a 10-60% overlap to provide multi-layer protection.

Historically, bitumen and petrolatum (by-products from the refining of crude oil) have been used for corrosion prevention tapes. Both these chemicals are comprised of relatively low molecular weight mixtures of aliphatic and/or aromatic organic compounds, utilized as much for their ready availability and low cost as their adhesive properties. Although both substances show exceptionally pronounced adhesion to steel, they have poor resistance to elevated temperature, in that their viscosity rapidly decreases as temperature increases. Furthermore, neither product can be ‘cured’ or ‘cross-linked’ to improve their thermal resistance or resistance to oils and solvents. Neither product shows good puncture resistance, in that there is no tendency to ‘self-heal’ (re-amalgamate) after being punctured and corrosion prevention tapes manufactured from both products are therefore susceptible to mechanical damage.

To impart added protection over a wider range of service conditions, traditional petrolatum or bitumen based tapes have recently been superseded by elastomeric products, based on IIR (isoprene-isobutylene) commonly known as ‘butyl’ rubber, and, most recently PIB (polyisobutylene) polymers. Butyl rubber and polyisobutylene are chemically very similar, differing only in that butyl rubber contains a small fraction of co-polymerized isoprene to allow vulcanisation.

Although PIB has good thermal stability (i.e. does not easily decompose at elevated temperature) the practical upper temperature limit of PIB's application is determined by the polymer's inability to be cross-linked, i.e. vulcanized. Likewise, resistance to oils and solvents is limited by the same characteristic. Only the low molecular weight PIB grades exhibit tack, from which their adhesive properties are derived. Low molecular weight/low viscosity polymers also exhibit the same limiting physical characteristics as bitumen and petrolatum. However, the slightly higher molecular weight and viscosity of PIB does impart some degree of ‘self-healing’ at the site of a mechanical puncture, provided a PVC outer wrap is applied, to provide the necessary compressive force. PVC shows a tendency to shrink with time; this tendency is accelerated by high ambient temperatures. Hence, PVC is often the outer wrap material of choice, although other materials, such as polyethylene and polypropylene, can also be employed.

PIB is a saturated hydrocarbon polymer, containing no hetero atoms or functional groups. As such, PIB is inherently non-polar and relies on adhesive bond formation via Van der Waal forces alone. Polar, performance promoting additives also show limited solubility in non-polar systems, such as PIB. Indeed, commercially available PIB corrosion tapes contain no such additives.

As mentioned hereinbefore, PIB cannot be vulcanized, since a spontaneous, competing, polymer chain scission reaction proceeds at the same rate as the ‘cross-linking’ or vulcanisation reaction. PIB can, however, be polymerized to very high molecular weight, without gel (cross-linked bundle) formation, which becomes progressively more problematic as chain extension proceeds. Butyl rubber is typically produced with molecular weights (MW) in the 100000 to 350000 range, whereas PIB can be polymerized to give molecular weights in excess of 1.5 million. High MW provides advantages in the formulation of the adhesive component. Conversely, many low MW PIB grades are also available, supplied as viscous liquids, but which exhibit no elastic recovery after deformation. The high MW grades are tough, rubbery solids with typical visco-elastic or ‘rubbery’ properties. Low MW grades are inherently tacky, and when blended with suitable diluents and/or fillers and supported on a carrier, can be formulated to give paste adhesives with the desired properties, but lacking resilience or elastic recovery.

It is an aim of this invention to provide a corrosion resistant tape whereby drawbacks associated with known corrosion protection tapes, such as inadequate adhesion of the tape components to one another as well as to substances, unsuitability for use at high service temperatures, etc. are addressed, or at least to provide a commercially useful alternative thereto.

### SUMMARY OF INVENTION

Thus, according to a first aspect of the invention, there is provided a corrosion prevention tape for wrapping an irregular pipe section, the tape comprising:
an adhesive component, the adhesive component comprising:
   from 10 to 50 wt % functionally modified elastomer, and
   from 0.1 to 20 wt % discrete reinforcing strands dispersed within the adhesive component; and
(ii) a backing layer for the adhesive component.

The present inventors have found that the inclusion of a functionally modified elastomer results in improved adhesion to steel substrates and improved self-healing properties relative to the petrolatum/PIB-based tapes of the prior art. The inclusion of a relatively small quantity of discrete reinforcing strands confers a sufficiently high tensile strength to the adhesive component for its intended use. Advantageously, the functionally modified elastomer can be cured to confer good heat resistance for high-temperature applications.

Nevertheless, it has been found that the discrete reinforcing strands themselves significantly increase the heat resistance of the adhesive component. This means that for high temperature applications, the adhesive component can actually remain uncured (i.e. no curing system is required) provided the outer wrap used with the corrosion prevention tape can be cured. This, in turn, prevents any transition of the adhesive component to an elastic state and allows for adhesive flow and self-healing to be retained in the claimed system, even at high operating temperatures.

The present invention will now be further described. In the following passages different aspects of the invention are defined in more detail. Each aspect described and the individual features thereof may be combined with any other aspect or aspects unless clearly indicated to the contrary. In particular, any feature indicated as being preferred or advantageous may be combined with any other feature or features indicated as being preferred or advantageous. It will be recognised that features described in the context of one aspect may be combined with other aspects where appropriate.

The present invention relates to a corrosion prevention tape (CPT) for wrapping an irregular pipe section. By “tape” it is meant a strip of material in sheet form usable to cover a surface. The tape is suitable for wrapping an irregular pipe section. Examples of irregular pipe sections include flanges, valves, elbows and joints, such as T-joints. The term “irregular” pipe section is therefore intended to cover pipe sections that are irregular in cross-section. Preferably the pipe section is unprimed. In other words, the tape is suitable for wrapping an irregular pipe section without requiring a priming or other pre-treatment step. Preferably the irregular pipe section is an irregular steel pipe section, more preferably a steel pipe. Conformability, mouldability and ease of application are important for such applications. Unlike tapes of the prior art, the tape of the present invention combines excellent adhesion to steel with excellent conformability and adhesive flow while maintaining a suitably high tensile strength, rendering it particularly suitable for the uses described herein. While the tape is particular suited to application to pipe sections of irregular cross-section, it can also be used to wrap a regular pipe section and indeed the full length of a pipe.

The tape will typically be provided on a reel for ease of use. Preferably the tape has a length of from 10 to 30 m and and/or a width of from 100 to 450 mm. Preferably the tape has a thickness of from 1 to 3 mm, more preferably from 1.5 to 2.5 mm. This includes the thickness of the adhesive component and the backing layer. It does not include the thickness of the release film, where present. In use, the tape may be wrapped around a substrate such that adjacent portions of the tape overlap, preferably by from 20 to 80%.

The tape may be applied manually or by machine. The tape may be applied at room temperature. Alternatively, the tape may be warmed immediately prior to application.

By “corrosion prevention” it is meant that the tape serves to provide corrosion resistance to the wrapped substrate. Corrosion is a natural process which is the gradual destruction of metals to their oxides by chemical reaction with their environment. Thus, the tape serves to reduce or avoid contact between the metal portions of joints or pipes and their environment. By substantially excluding moisture and air the longevity of the joint is prolonged.

The tape comprises an adhesive component. The adhesive component comprises from 10 to 50 wt % functionally modified elastomer, preferably from 10 to 30 wt %, more preferably from 12 to 20 wt %, expressed by weight of the adhesive component. By “elastomer” it is meant a polymer that can be stretched and that returns to its original shape or length without significant permanent deformation. By “functionally modified elastomer” (FME) it is meant an elastomer which has pendent and/or terminal functional groups. Preferably, these functional groups are polar functional groups. The nature, make-up, positioning, etc. of the functional groups will determine the physical and/or chemical properties of the elastomer, and will thus be selected to impart desired properties, e.g. substrate adhesion, to the adhesive component.

Preferably, the FME has a glass transition temperature (Tg) of less than −20° C. Accordingly, the FME exhibits elastomeric rather than glass-like properties at the temperatures at which the tape will typically be used.

It will be appreciated that in order for the CPT to be functional, it must be applied to the substrate at a substrate temperature that is not so low that the adhesive component fully solidifies or becomes brittle, thereby losing its adhesive properties, and not so high that the adhesive component exhibits excessive flow or creep. Preferably, the tape is functional at a continuous operating temperature of up to 100° C., more preferably up to 130° C. For example, the tape may be functional at a continuous operating temperature of from −20 to 60° C., from 60 to 100° C. or from 100 to 130° C. It will be appreciated that the tape disclosed herein may have its composition tuned to the temperature at which it is intended to be deployed. For example, the FME will be selected so that its glass transition temperature is lower than the temperature of application. For high temperature applications, a curing system may be included in the adhesive component and/or the outer wrap, as described herein elsewhere.

As a result of the FME, the adhesive component is “self-healing”. By “self-healing” it is meant that the component has a sufficiently low viscosity to allow it to flow under pressure to fill any points of damage, but sufficiently high to prevent downwards flow in vertical installations. The self-healing tendency is promoted by both the spontaneous recovery of elastomeric materials, upon the removal of any external deformational force, and from the inward compressive force provided by the tension applied to the outer wrap.

Preferably, the FME has weight average molecular weight of from 50,000 to 400,000 g/mol. The adhesive component, by virtue of the high molecular weight of the FME, exhibits the desirable characteristic of recovery after limited deformation. Elasticity is beneficial when the CPT, in use, spans regions of varying thermal expansion, such as gaskets used in steel flanges. Elasticity and resilience are pronounced in elastomers of high MW.

Another benefit of the use of high MW FMEs is that when compounded as hereinafter described, higher green strength i.e. the strength of the uncured adhesive component, result. Higher green strength results in higher peel strength, i.e. resistance to detachment, and also higher flow and creep resistance of the adhesive component.

High MW elastomers, as supplied by a manufacturer, are sometimes of little use unless additives are incorporated or compounded therein to modify their sometimes dry, rubbery, elastic form. Additives may be chosen to optimise many of the desirable attributes of the polymer, as described herein. Many physical characteristics can be effectively modified by the choice of a very wide range of possible additives. The combination of an elastomer with an incorporated modifying additive is often referred to as an ‘elastomeric compound’ and the additive as a ‘compounding ingredient’. Suitable compounding ingredients are described herein.

Resistance to moisture penetration is also a very important criterion with which the FME, and hence the adhesive component, must comply. Further selection criteria which may be borne in mind include: long term stability; molecular weight and green strength; resistance to oxidative degradation; cathodic corrosion inhibition; cost. The thermal stability of the CPT is also of importance, since it allows the same tape to be applied to systems that operate over a range of service temperatures.

Preferably, the FME comprises an elastomeric backbone including a plurality of side chains bearing at least one polar functional group. Preferably, the FME comprises a plurality of monomer units, wherein at least 25 wt % of the plurality of monomer units comprise at least one polar functional group, more preferably at least 50 wt %, still more preferably at least 75 wt %. Elastomers containing polar functional groups are able to form Van der Waal bonds as well as additional ‘hydrogen’ bonds with the substrate, leading to increased bond strengths. Hydrogen bond formation is promoted by the polar nature of the selected FME, leading to high bond strengths to both a steel substrate and a polyvinyl chloride backing layer, since both have polar surface groups. Hydrogen bonds are of the electrostatic type, which form between polar atoms such as nitrogen, oxygen and halogens and can be as high as 5 kCal/mol. For the bonds to form, close proximity must be established between the adhesive and the substrate, which requires good ‘wetting’ of the substrate by the adhesive. Good wetting is enhanced by adhesives with low surface tension. Advantageously, good wetting also promotes the formation of Van Der Waals adhesive bonds and the FME CPTs are able to optimize both bond types. Furthermore, the low surface tension and good surface wetting properties enable the CPT to bond to non-polar substrates such as polyethylene (PE) or polypropylene (PP). Since steel pipes can sometimes be supplied with a PE corrosion resistant coating (applied during manufacture), good adhesion to this non polar surface is also achieved. The adhesion prevents moisture ingress at the steel/PE interface. Indeed, where commercially or technically advantageous, both PE and PP can be employed as the CPT backing film, as replacement of PVC. Preferably, the at least one polar functional group is selected from the group consisting of a carboxyl, halo, chlorosulfanyl, epoxy, nitrile, styrenyl, sulphide and mixtures of two or more thereof.

FMEs are well-known to those skilled in the art. The FME is preferably selected from the group consisting of an acrylic polymer, a carboxylic polymer, polychloroprene, chlorinated polyethylene, a chlorosulphanyl polymer, a epichlorohydrin polymer, an ethylene acrylic copolymer, isobutylene-paramethylstyrene copolymer, a nitrile polymer, a blend of PVC and a nitrile polymer, polysulphide polymer, a styrene butadiene copolymer, and mixtures of two or more thereof.

More preferably, the FME may be selected from the following elastomers or mixtures thereof which may be formulated to yield adhesive components whose properties may be optimized on a cost/performance basis; the selection criteria may include cost, availability, moisture resistance, degradation resistance, molecular weight, green strength, and additive compatibility.
a) carboxylic polymer
b) chlorinated polyethylene
c) chlorosulphonated polyethylene
d) polychloroprene
e) nitrile polymer
f) a blend of a nitrile polymer and PVC

It is to be understood that the FME may be a homopolymer. For example, where the FME is a halo polymer, the FME may be polymer of chloroprene, monomer units. Alternatively, the FME may be a copolymer. Where the FME is a copolymer, it preferably comprises at least 20 wt %, more preferably at least 28 wt %, of the relevant monomer unit by weight of the FME. For example, where the FME is a copolymer of acrylonitrile monomer units, with one or more other monomer units, the FME preferably comprises at least 20 wt %, more preferably, at least 28 wt %, acrylonitrile monomer units by weight of the FME.

The above elastomers may also be blended to combine their individual attributes. The addition of compounding ingredients can also modify the properties of the elastomer, providing versatility in optimizing the most suitable adhesive component formulation for the prevailing commercial environment.

As a result of the conformability and mouldability conferred to the adhesive component by the FME, together with its enhanced adhesion to steel relative to the petrolatum/PIB-based tapes of the prior art, the present CPT is particularly suited to wrapping irregular steel pipe sections. This is noted above.

A variety of compounding ingredients may be included in the adhesive component. Preferably, the adhesive component further comprises from 25 to 70 wt % filler by weight of the adhesive component, more preferably from 40 to 60 wt %. Preferably, the filler is a hydrophobic mineral filler. Preferably, the filler is selected from the group consisting of a clay-based mineral filler (such as kaolin), magnesium silicate-cased mineral filler (such as talc), and mixtures of two or more thereof. The mineral filler is most preferably talc. The mineral filler reduces cost and have good moisture resistance. It also promotes reduction of the surface tension between the adhesive component and the substrate to which the tape is applied, thereby aiding adhesion.

Alternatively or in addition, the adhesive component may comprise from 0.05 to 2.5 wt % adhesion promoter by weight of the adhesive component, more preferably from 0.05 to 1 wt %. Preferably, the adhesion promoter is a thiosilane. The adhesion promoter serves to further improve adhesion to a steel substrate. It also promotes coupling between the FME and the mineral filler (where present) and labile cross-link formation. Moreover, the adhesion promoter improves high-temperature flow resistance. Alternative adhesion promoters include liquid carboxylated nitrile butadiene rubber, which also enhance surface tack.

Where higher concentrations of adhesion promoter are employed, it is possible to substantially increase the formation of labile cross links between polymer chain, filler particle and adjacent chain. The adhesive component may be processed at moderate temperature, with labile links spontaneously reforming as the material cools. The adhesive then exhibits the advantages of higher flow and creep resistance without losing adhesion to steel. A heat treatment (tempering) cycle may be introduced in the manufacturing process to encourage thiosilane induced labile cross link formation. Direct chain-to-chain cross links are introduced during the conventional elastomeric vulcanisation reaction, for example by the inclusion of elemental sulphur or an organic peroxide. However, vulcanization bonds are co-valent and thermally stable and adhesive containing such bonds would become unprocessable during manufacture.

The attribute of controllably forming labile thiosilane cross-links enables the FME adhesive component to be conventionally processed, but without losing the thermal stability enhancements (flow and creep resistance) of a cross linked polymer. The silane has the additional advantage of enhancing the adhesive's adhesion to steel, via the same chemical mechanism.

Alternatively or in addition, the adhesive component may comprise from 5 to 40 wt % plasticizer by weight of the adhesive component, more preferably from 10 to 20 wt %. The plasticizer is preferably selected from the group consisting of chlorinated paraffin, organo phosphates or phthalates, aromatic hydrocarbons and mixtures of two or more thereof. The plasticizer has good moisture resistance and helps to reduce surface tension, thereby aiding adhesion. The plasticizer may also act as a combined plasticizer/tackifier.

Alternatively or in addition, the adhesive component may comprise from 5 to 30 wt % tackifying resin by weight of the adhesive component, more preferably from 8 to 16 wt %. The tackifying resin is preferably selected from the group consisting of a hydrocarbon tackifying resin, a phenolic tackifying resin, a rosin ester, a liquid coumarone resin and mixtures of two or more thereof. The tackifying resin improves surface tack and promotes adhesion of the adhesive component to a steel substrate and/or to the backing layer.

Further additives, such as anti-oxidants and colour modifiers, may also be included. Suitable additives for such purposes are well-known to those skilled in the art and include substituted phenol antioxidants and phthalocyanine pigments.

The adhesive component comprises from 0.1 to 20 wt % discrete reinforcing strands dispersed within the adhesive component, preferably from 0.1 to 10 wt %, more preferably from 0.1 to 3 wt %, and still more preferably from 0.1 to 2 wt %, expressed by weight of the adhesive component. By “discrete” it is meant that the strands are present as individual linear strands. The discrete reinforcing strands do not form a mesh or a fabric reinforcement. The discrete reinforcing strands are present in an amount sufficient to reinforce the adhesive component, without compromising its adhesion to a steel substrate. This improves the heat resistance of the adhesive component, since its reduction in viscosity at high temperatures is lessened. Surprisingly, the present inventors have found that the effect of even a small quantity of discrete reinforcing strands (such as from 0.1 to 3 wt % or from 0.1 to 2 wt %) on heat resistance that there is no need to include a vulcanizable component for high-temperature applications of up to 130° C. (or even up to 140° C. intermittently) provided that the tape is used in combination with a vulcanizable outer wrap. This, in turn, prevents any transition of the adhesive component to an elastic state and allows for adhesive flow and self-healing to be retained in the claimed system, even at high operating temperatures.

The discrete reinforced strands may, in particular, be lengths of textile fibre strands. The lengths of textile fibre strands may be chopped fibre strands. In particular, the textile fibre may be a synthetic textile fibre. Without the strands, the adhesive component would be soft and extensible, with low tensile strength. The dispersed chopped textile fibre strands thus act both as a thermal and mechanical reinforcing media for the adhesive component.

The strands are present in, i.e. admixed with, the adhesive component at relatively low concentration to form an adhesive component/fibre composite, i.e. the reinforced adhesive component. Preferably the discrete reinforcing strands are dispersed uniformly throughout the adhesive component.

Yet another benefit of dispersed chopped synthetic fibre (CSF) reinforcement is that the adhesive component becomes reinforced and hence resistant to flow and creep at elevated temperature. CPTs that rely on reinforcing layers or carriers may allow shear, creep or delimitation to occur at the reinforcing layer/adhesive component interface.

The fibre or strand composition, physical properties and dimensions all play an important role in the properties of the composite. The reinforcing fibre or strand selected should have high tenacity (a measure of the textile's strength in relation to its mass); it should exhibit good adhesion to the adhesive component; it should be impervious to moisture; it should have good cost/performance properties; its length-to-diameter ratio should be high; it should have minimal effects on the desirable, adhesive qualities of the adhesive component.

Common synthetic fibre materials such as glass, nylon or rayon may be used as the material of the fibres or strands; however, polyester is preferred since it provides good all-round properties. Chopped polyester strands, produced from recycled polymer, are readily available in many lengths and diameters (tex), at moderate cost, and meet all the selection criterion mentioned above.

Preferably, the discrete reinforcing strands have a length of from 2 to 8 mm. Even low additions of such fibres (e.g. from 0.1 to 3 wt % or from 0.1 to 2 wt %) have a very marked effect on the physical properties of the adhesive component but little negative effect on adhesion thereof to substrates, particularly steel substrates. The present inventors have found that whereas longer strands (e.g. 12 mm) tend to become oriented in the longitudinal tape direction during processing, shorter strands (2 to 8 mm) are more randomly distributed. The random distribution has been found to provide the benefit of resisting flow and creep at elevated temperature without unduly affecting adhesive strength.

Higher concentrations of longitudinally aligned strands provide good tensile reinforcement but have a severe effect on adhesion to steel, since they markedly increase the surface tension, and hence surface wetting tendency, of the adhesive component. The more randomly distributed shorter strands have been found to have a more limited effect on longitudinal or lateral reinforcement, but are highly effective in enhancing creep and flow resistance.

Preferably, the discrete reinforcing strands include strands having a length of from 2 to 4 mm and strands having a length of from 5 to 8 mm, wherein the strands having a length of from 2 to 4 mm and the strands having a length of from 5 to 8 mm are present in a weight ratio of from 1:5 to 1:50, more preferably from 1:10 to 1:40. Preferably the discrete reinforcing strands consist of strands having these lengths. The present inventors have found that this blend of strand lengths provides optimal resistance to flow and creep and good tensile reinforcement without significantly reducing steel adhesion. In some embodiments, the adhesive component is vulcanizable. That is, the adhesive component is cross-linkable at the substrate temperature. In these embodiments the CPT is particularly suited for use on substrates which are at elevated temperature, particularly at temperatures of 100° C. or higher, such as from 100 to 130° C., with little or no flow and creep of the adhesive component at the high substrate temperatures. When the CPT is then applied to a hot substrate which is at a temperature of at least 100° C., cross-linking of polymers making up the adhesive component takes place. Not only are chemical bonds formed between the FME polymer chains, but also between the adhesive component and the substrate. The formation of chemical bonds within the adhesive and at the substrate/adhesive interface allows the CPT to be used continuously at temperatures as high as 130° C., and even with peak intermittent substrate temperatures of 140° C. For prolonged high temperature exposure, proprietary rubber-to-metal bonding agents can be applied to the clean, abraded steel before the application of the vulcanizable, high temperature FME tape. The bonding agents are commercially available under the trade name ‘Chemlock’, supplied by the Lord Corporation.

In these embodiments, the adhesive component preferably comprises a curing system which permits vulcanization of the adhesive component. The curing or vulcanization system will naturally be dependent on the FME used in the adhesive component to enhance the resistance of the CPT to elevated temperature.

It will be appreciated that, as regards the curing system, the type of cross-link introduced, its concentration in the adhesive component, and its chemical formulation, influence the properties of the resultant vulcanized product, i.e. the adhesive component, in particular its resistance to degradation at high temperature.

The curing system may comprise one or more of the following: a curing activator such as zinc oxide and/or stearic acid; a vulcanization accelerator such as cyclohexyl benzathiazole sulphonamide and/or tetramethyl thiuram disulphide; and a curing agent such as a sulphur donor, e.g. dimorpholene. Each of the curing activator, curing agent, and vulcanization accelerator may typically be present in an amount of from 0.1 to 2 wt % by weight of the adhesive component.

Naturally, if desired, the vulcanizable adhesive formulation can also be such that the CPT can be used for low temperature applications, i.e. used on substrates which are at a temperature of 100° C. or less.

While the adhesive component may be vulcanizable, it is nevertheless noted above that this is not in fact necessary even for high-temperature applications provided the tape is used in combination with a vulcanizable outer wrap. This is a result of the heat resistance conferred by the discrete reinforcing strands. Thus, in some embodiments, the adhesive component is not vulcanizable (i.e. it does not comprise a curing system). In some embodiments, the adhesive component comprises, on a mass basis, i.e. expressed as parts by mass per hundred parts by mass elastomer, the following:

| | Range | Typical value (approx) |
|---|---|---|
| FME | 100 | 100 |
| filler | 75-150 | 350 |
| plasticiser | 70-150 | 115 |
| tackifying resin | 50-125 | 85 |
| other additives | 1-7 | 3 |

More particularly, the adhesive component may comprise, on the same mass basis, the following:

| | Range | Typical value (approx) |
|---|---|---|
| first FME | 70-100 | 85 |
| second FME | 0-30 | 15 |
| mineral filler | 75-150 | 120 |
| first plasticiser | 30-70 | 40 |
| second plasticiser | 40-80 | 75 |
| first tackifying resin | 25-50 | 25 |
| second tackifying resin | 25-75 | 60 |
| adhesion promoter | 2.5-7.0 | 4.5 |
| first antioxidant | 0.5-1.5 | 1.2 |
| second antioxidant | 0.5-1.5 | 1.0 |
| colour modifier | 0.3-1.5 | 0.3 |

In other embodiments, the adhesive component comprises, on a mass basis, i.e. expressed as parts by mass per hundred parts by mass elastomer, the following:

| | Range | Typical value (approx) |
|---|---|---|
| FME | 100 | 100 |
| filler | 75-150 | 120 |
| plasticiser | 70-175 | 115 |
| tackifying resin | 25-75 | 60 |
| curing system | 7-15 | 10 |
| other additives | 1-7 | 3 |

More particularly, the adhesive component may then comprise, on the same mass basis, the following:

| | | Typical value |
|---|---|---|
| | Range | (approx) |
| FME | 100 | 100 |
| filler | 75-150 | 120 |
| first plasticiser | 30-70 | 40 |
| second plasticiser | 40-80 | 75 |
| tackifying resin | 25-75 | 60 |
| first curing activator | 3-6 | 4 |
| second curing activator | 0.4-1.8 | 1 |
| first vulcanization accelerator | 1.0-2.5 | 1.5 |
| second vulcanization accelerator | 0.3-1.0 | 0.3 |
| curing agent | 2.5-4.0 | 3.0 |
| adhesion promoter | 2.5-7.0 | 4.5 |
| first antioxidant | 0.5-1.5 | 1.2 |
| second antioxidant | 0.5-1.5 | 1.0 |
| colour modifier | 0.3-1.5 | 0.3 |

The adhesive component may comprise, in another embodiment of the invention, and on the same mass basis as defined above, the following:

| | Range | Typical value (approx) |
|---|---|---|
| FME | 100 | 100 |
| impact modifier | 0-20 | 5 |
| filler | 50-150 | 120 |
| plasticiser | 70-150 | 50 |
| tackifying resin | 25-75 | 30 |
| curing system | 7-16 | 10 |

More particularly, the adhesive component may then comprise, on the same mass basis, the following:

| | | Typical value |
|---|---|---|
| | Range | (approx) |
| FME/PVC preblend | 120-140 | 120 |
| impact modifier | 0-20 | 5 |
| filler | 50-150 | 120 |
| first plasticiser | 30-70 | 20 |
| second plasticiser | 40-80 | 30 |
| tackifying resin | 25-75 | 30 |
| first curing activator | 3-6 | 4 |
| second curing activator | 0.4-1.8 | 1 |
| first vulcanization accelerator | 1.0-2.5 | 1.5 |
| second vulcanization accelerator | 0.3-1.0 | 0.7 |
| curing agent | 2.5-4.0 | 3.0 |
| adhesion promoter | 0.5-2.5 | 0.7 |
| first antioxidant | 0.5-1.5 | 1.5 |
| second antioxidant | 0.5-1.5 | 1.5 |
| UV stabilizer | 3.0-5.0 | 3 |

The adhesive component is preferably homogeneous. In other words, the substances which make up the adhesive component preferably form a homogeneous mixture, with the discrete reinforcing strands dispersed uniformly throughout the adhesive component.

In certain preferred embodiments, the adhesive component comprises from 10 to 30 wt % functionally modified elastomer and from 0.1 to 10 wt % discrete reinforcing strands.

In certain preferred embodiments, the adhesive component comprises:

from 10 to 30 wt % functionally modified elastomer selected from the group consisting of a carboxylic polymer, a chlorinated polyethylene, a chlorosulphonated polyethylene, a nitrile polymer, a blend of nitrile polymer and PVC, and mixtures of two or more thereof, the functionally modified elastomer having a weight average molecular weight of from 50,000 to 400,000 g/mol and comprising at least 20 wt % of the relevant monomer unit by weight of the FME;

from 0.1 to 10 wt % discrete reinforcing strands;

from 15 to 70 wt % mineral filler selected from the group consisting of a clay-based mineral filler, a magnesium silicate-based mineral filler, and mixtures of two or more thereof;

from 0.05 to 2.5 wt % adhesion promoter selected from a thiosilane and/or a liquid carboxylated nitrile butadiene rubber;

from 5 to 40 wt % plasticizer selected from the group consisting of chlorinated paraffin, organo phosphates or phthalates, aromatic hydrocarbons and mixtures of two or more thereof;

from 5 to 30 wt % tackifying resin selected from the group consisting of a hydrocarbon tackifying resin, a phenolic tackifying resin, a rosin ester, a liquid coumarone resin and mixtures of two or more thereof;

and, optionally, a curing system.

In certain preferred embodiments, the adhesive component comprises:

from 10 to 30 wt % functionally modified elastomer (FME), wherein the FME is a blend of: (i) chlorosulphonated polyethylene having a weight average molecular weight of from 50,000 to 400,000 g/mol and comprising at least 20 wt % chlorosulphonated ethylene units by weight of the chlorosulphonated polyethylene, and (ii) chlorinated polyethylene having a weight average molecular weight of from 50,000 to 400,000 g/mol and comprising at least 20 wt % chlorinated ethylene units by weight of the chlorinated polyethylene;

from 0.1 to 10 wt % discrete reinforcing strands;

from 15 to 70 wt % clay-based mineral filler;

from 0.05 to 2.5 wt % thiosilane adhesion promoter; and

from 5 to 40 wt % aromatic hydrocarbon plasticizer.

In certain preferred embodiments, the adhesive component comprises:

from 10 to 30 wt % functionally modified elastomer (FME), wherein the FME is a nitrile polymer having a weight average molecular weight of from 50,000 to 400,000 g/mol and comprising at least 20 wt % nitrile units by weight of the FME, preferably wherein the FME is an acrylonitrile butadiene rubber;

from 0.1 to 10 wt % discrete reinforcing strands;

from 15 to 70 wt % clay-based mineral filler;

from 0.05 to 2.5 wt % thiosilane adhesion promoter;

from 5 to 40 wt % aromatic hydrocarbon plasticizer; and

one or more of a curing activator, a curing agent and a vulcanization accelerator, each optionally being present in an amount of from 0.1 to 2 wt % by weight of the adhesive component.

In certain preferred embodiments, the adhesive component comprises:

from 10 to 30 wt % functionally modified elastomer (FME), wherein the FME is a blend of a nitrile polymer and PVC, preferably wherein the nitrile polymer is a nitrile butadiene polymer;

from 0.1 to 10 wt % discrete reinforcing strands;

from 15 to 70 wt % clay-based mineral filler;

from 0.05 to 2.5 wt % thiosilane adhesion promoter;

from 5 to 40 wt % aromatic hydrocarbon plasticizer; and

one or more of a curing activator, a curing agent and a vulcanization accelerator, each optionally being present in an amount of from 0.1 to 2 wt % by weight of the adhesive component.

The CPT comprises a backing layer for the adhesive component. It is to be understood that the backing layer and the adhesive component are in direct contact. The adhesive component may form discrete islands on the surface of the backing layer. Preferably, however, the adhesive component forms a continuous layer.

While any suitable backing layer or film can be used, the composition forming the backing layer preferably comprises, consists essentially of or consists of polyvinyl chloride (PVC). Not only does PVC have good mechanical strength and high modulus, but it also shows a tendency to shrink with time—a tendency accelerated by elevated ambient temperature. The adhesion between the adhesive component and the backing film is also important since the CPT is applied in an overlapping manner, to ensure that the steel substrate is completely covered. At the overlap, the underside of the adhesive component comes into contact with the outer side of the backing film, and hence a water resistant barrier is required.

The polar nature of the FME-based adhesive component allows the formation of hydrogen bonds between the adhesive component and the backing film, in the same way as the polar nature of steel encourages the same phenomenon. The surface wetting effect, and formation of Van der Waals adhesive interactions, is complimented by the formation of hydrogen bonds, which accounts for the high degree of adhesion attained between the adhesive component and the PVC backing film. Hydrogen bonds are of the electrostatic type, which form between polar atoms such as nitrogen, oxygen and halogens and can be as high as 5 kCal/mol. For the bonds to form, close proximity must be established between the adhesive and the backing film, which requires good ‘wetting’ of the substrate by the adhesive. Good wetting is enhanced by adhesives with low surface tension. Advantageously, good wetting also promotes the formation of Van Der Waals adhesive bonds and the FME CPT's are able to optimize both bond types. Furthermore, the low surface tension and good surface wetting properties enable the CPT to bond to non-polar substrates such as polyethylene (PE) or polypropylene (PP). Since steel pipes can sometimes be supplied with a PE corrosion resistant coating (applied during manufacture), good adhesion to this non polar surface is also achieved. The adhesion prevents moisture ingress at the steel/PE interface. Indeed, where commercially or technically advantageous, both PE and PP can be employed as the CPT backing film, as replacement of PVC.

The strong bonds formed between the PVC backing film and the FME polar adhesive component allow the composite adhesive component/CSF to be further reinforced and strengthened.

The tendency of PVC to shrink prevents the separation of the inner wrap from the underside of pipes to which it has been applied. The tendency of the inner wrap to separate or ‘bag’ on the underside of wrapped pipes is especially prevalent in high ambient temperature, where the use of PVC as the inner wrap backing film is especially beneficial.

Preferably, the CPT includes a release film covering the side of the adhesive component remote from the backing layer. In such embodiments, the adhesive component is sandwiched between and in direct contact with the backing layer and the release film. Preferably, the release film comprises a non-polar material (usually silicone-based) coated and cured onto a backing of paper, polyester film or polyethylene (PE) film. Silicone-coated high, medium and low density PE films are commercially available. The polarity of the FME has a pronounced effect on how the adhesive component will separate from the release film, which usually has a non-polar, inert surface. Without an effective release film, the adhesive component could become, in practical terms, unusable, since it will stick aggressively to any surface with which it comes into contact and therefore could not be transported, handled or applied effectively, without a release film. A polar adhesive component exhibits enhanced release from a non-polar release film and therefore can be formulated to have more aggressive adhesion to a substrate, particularly a substrate, such as a steel pipe or fitting. The selection of a polar FME allows the advantage of not only an additional adhesive bond type (surface wetting and hydrogen bonding) but also improved separation from the release film.

While other layers may be present, the tape preferably consists of the adhesive component, the backing layer and, optionally, the release film.

According to a further aspect of the invention, there is provided a kit for providing a pipe joint with corrosion protection, the kit comprising a corrosion prevention tape as described herein and a flexible wrapping tape. The flexible wrapping tape forms an “outer wrap” which may, in use, be provided adjacent to and adhering to the backing film of the CPT. Such an outer wrap can enhance the CPT's resistance to bagging and improve its impact resistance. When complemented by a PVC outer wrap, a more robust, impact corrosion protective CPT, results.

The outer wrap, when present, provides compression of the inner wrap, and also improved mechanical protection and impact resistance. The outer wrap is conventionally coated with a PSA (to resist moisture ingress to the inner wrap) and is wound in overlapping layers to provide the necessary thickness for the desired impact resistance.

Preferably, the composition forming the flexible wrapping tape comprises polyvinyl chloride (PVC). PVC outer wraps have been found to be particularly effective at achieving the above-described effects. Preferably, the composition forming the flexible wrapping tape comprises a vulcanizable rubber. Preferably, the vulcanizable rubber is selected from the group consisting of nitrile-butadiene rubber (NBR), polychloroprene rubber (CR), chlorinated polyethylene(CPE), chlorosulphonated polyethylene (CPE) and mixtures of two or more thereof. In some embodiments, the composition forming the flexible wrapping tape comprises a blend of PVC and NBR. PVC and NBR are compatible at a molecular level and can be blended in any ratio, effectively forming a vulcanizable PVC. As discussed above, the use of a vulcanizable flexible wrapping tape obviates the need to include a vulcanization system in the adhesive component of the CPT for high-temperature applications since the discrete reinforcing strands already provide significant heat resistance. The omission of a vulcanization system from the adhesive component can be advantageous since vulcanization can lead to a hardening of the adhesive or even a transition to an elastic state, diminishing its adhesive flow and self-healing capacity. Accordingly, the combination of the discrete reinforcing strands and a vulcanizable outer wrap allows for adhesive flow and self-healing to be retained in the claimed system, even at high operating temperatures.

The composition forming the flexible wrapping tape preferably further comprises a curing system which permits vulcanization of the vulcanizable rubber, more preferably wherein the curing system comprises one or more of the following: a curing activator, a vulcanization accelerator, and a curing agent. The choices of curing activator, vulcanization accelerator, curing agent are preferably as described above in relation to the adhesive component of the CPT.

According to a further aspect, there is provided a corrosion protected article, which includes a substrate covered by a corrosion prevention tape as described herein, with at least a portion of the adhesive component of the corrosion prevention tape adhering to the substrate. In other words, the substrate may be wrapped with the CPT. In particular, the CPT may be wrapped around the substrate with overlapping loops of the CPT, preferably wherein the overlap is from 20 to 80%. The substrate is preferably pipe section, more preferably a steel pipe section. The pipe section preferably includes a section of irregular cross-section, such as a flange, valve, elbow or joint. The substrate is preferably unprimed, the CPT preferably being applied directly to the substrate.

Preferably, the article is further provided with a flexible wrapping tape as described herein provided on the corrosion prevention tape. In other words, the corrosion prevention tape may itself be wrapped with the flexible wrapping tape. In particular, the flexible wrapping tape may be wrapped around the CPT with overlapping loops of the flexible wrapping tape.

According to a further aspect, there is provided a method of protecting a substrate against corrosion, the method comprising wrapping the substrate with a corrosion prevention tape as described herein such that at least a portion of the adhesive component of the corrosion prevention tape adheres to the substrate. In particular, the CPT may be wrapped around the substrate with overlapping loops of the CPT, preferably wherein the overlap is from 20 to 80%. The substrate is preferably pipe section, more preferably a steel pipe section. The pipe section preferably includes a section of irregular cross-section, such as a flange, valve, elbow or joint. The substrate is preferably unprimed, the CPT preferably being applied directly to the substrate.

Preferably, the method further comprises binding the corrosion prevention tape with a flexible wrapping tape as described herein. A detailed exemplary method of using the corrosion prevention tape or kit to protect a substrate will now be provided.

### FIGURES

The present invention will now be described in relation to the following non-limiting FIGURE:

FIG. 1 shows a diagrammatic three-dimensional view of a portion of a corrosion prevention tape (CPT) in accordance with the invention.

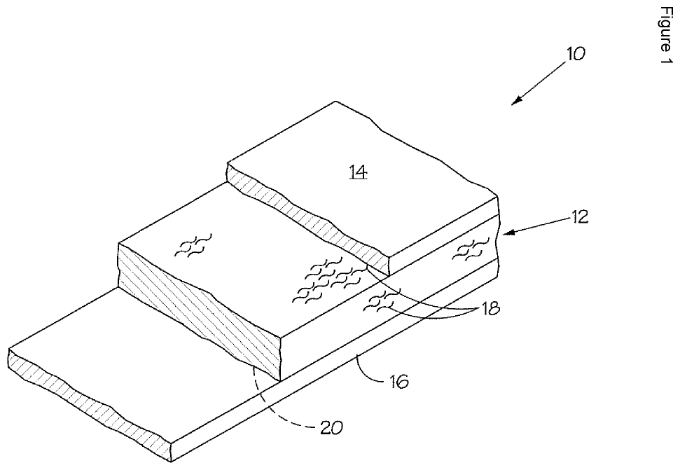

In the FIGURE, reference numeral 10 generally indicates a corrosion prevention tape according to the invention.

The tape 10 includes an adhesive component, generally indicated by reference numeral 12, sandwiched between a PVC backing layer 14 and a removable disposable release film 16.

The adhesive component comprises a functionally modified elastomer (FME). The adhesive component 12 is pliable at the temperature at which the tape is applied to a substrate.

Discrete reinforcing chopped polyester fibres 18 are dispersed within the adhesive component 12, and are aligned with the parallel longitudinal edges of the tape 10. A vulcanizable PVC flexible sleeve (not shown) can be provided against, and adhering to, the PVC backing layer 14, with the adhesive component 12 and PVC backing layer 14 thus constituting an inner wrap.

In use, the CPT 10 is applied to a substrate (not shown) such as a steel pipe, to prevent corrosion of the pipe. It is applied by removing the disposable release film and then winding the thus exposed undersurface 20 of the adhesive component 12 against the pipe and wrapping the tape 10 continuously around the pipe so that a portion of the undersurface 20 of a particular loop of the tape 10 around the pipe abuts both the pipe as well as a portion of the backing film of the preceding tape loop.

The adhesive component 12 ensures good adhesion to both the pipe and to the backing film 14. Thus, the adhesive component 12 forms the steel adhesive component of the CPT 10 and represents the bulk of its mass. The effectiveness of the adhesive component is of crucial importance to the effectiveness of overall protective inner/outer wrap system, since the adhesive component's adhesion to steel is the foundation of the CPT.

It has been found that the CPT of the invention is, as regards its application to substrates, reasonably tolerant to variations in surface preparation. The adhesive component surface wetting characteristics hereinbefore described are exhibited with a broad range of substrates after minimum of surface preparation. Hydrogen bonds form with any polar substrate, to enhance the Van der Waal's bonds formed from surface wetting.

However, substrate contaminants, such as oil, grease and moisture, should be removed, prior to wire brushing to remove loose surface solid contaminants. The quality of surface preparation, prior to the application of the CPT, preferably complies with ISO standards. For consistent, durable protection, preparation to St. 2 (wire brushing) is recommended.

For CPT applications, a crucial property of the adhesive component is robust adhesion to steel substrate over as wide a range of service conditions as possible. Since PVC film has the most desirable all-round physical characteristics for both adhesive component backing film and outer wrap applications, good adhesion to PVC is necessary, not only to prevent water ingress at the PVC/adhesive component interface but also when the inner wrap is wound onto a steel structure. An overlapping technique is employed, as the pipe is wrapped, to provide multi-layer corrosion protection and the adhesive must therefore also bond to the reverse side of the backing film.

In order for strong, durable adhesive bonds to be formed between steel and elastomeric coverings, an adhesive solution is conventionally applied to the cleaned, abraded steel surface. Such solutions are commercially available under the Lord Corporation brand name ‘Chemlock’.

### EXAMPLES

The present invention will now be described in relation to the following non-limiting examples.

### Example 1

A CPT in accordance with the invention was made up to have a reinforced adhesive component composition as set out in Table 1.

The CPT can be supplied to suit low to moderate temperature, i.e.—20 to 60 C, and elevated temperatures i.e. 60-100° C., applications, but equally can be used in high temperature applications (e.g. up to 130° C.) provided it is used in combination with both a vulcanizable FME adhesive, vulcanizable outer wrap and rubber-to-metal bonding agent, such as that provided in Example 3.

TABLE 1

| | | PARTS PER HUNDRED | | |
|---|---|---|---|---|
| GENERIC | | OF ELASTOMER | | |
| INGREDIENT | | | PRE- | INGREDIENT |
| NAME | DESCRIPTION | RANGE | FERRED | FUNCTION |
| CSM | CHLOROSULPHONATED | 70-100 | 85 | ELASTOMER |
| | POLYETHYLENE | | | |
| CPE | CHLORINATED | 0-30 | 15 | ELASTOMER |
| | POLYETHYLENE | | | |
| TALC | MINERAL FILLER | 75-150 | 120 | HYDROPHOBIC |
| | | | | DILUENT FILLER |
| | | | | ADHESION |
| | | | | PROMOTER/ |
| | | | | FILLER |
| S | THIO SILANE | 2.5-7.0 | 4.5 | COUPLING |
| SILANE | | | | AGENT |
| LIQUID CNBR | CARBOXXYLATED | 2.0-6.0 | 4.0 | ADHESION |
| | NITRILE RUBBER | | | PROMOTER/ |
| | | | | TACKIFIER |
| CHLORINATED | CHLORINATED | 30-70 | 40 | PLASTICISER |
| POLYETHYLENE | PARAFFIN | | | |
| PALE LIQUID | LIQUID COUMARONE | 40-80 | 75 | PLASTICIZER/ |
| CIR | INDENE RESIN | | | TACKIFIER |
| BKF | SUBSTITUTED PHENOL | 0.5-1.5 | 1.2 | NON-STAINING |
| | ANTI-OXIDANT | | | ANTIOXIDANT |
| TMQ | SUBSTITUTED PHENOL | 0.5-1.5 | 1.0 | NON-STAINING |
| | ANTI-OXIDANT | | | ANTIOXIDANT |
| C5 RESIN | HYDROCARBON | 25-50 | 25 | TACKIFYING |
| | TACKIFYING RESIN | | | RESIN |
| GUM ROSIN | ROSIN ESTER | 10-40 | 20 | TACKIFYING |
| | | | | RESIN |
| MICROLITH | PHTHALOCYANINE | 0.3-1.5 | 0.3 | COLOUR |
| BLUE | PIGMENT | | | MODIFIER |
| POLYESTER | CHOPPED POLYESTER | 2-4 | 3.0 | TENSILE |
| STAPLE | YARN, 6 mm, 1.2 dtex | | | REINFORCEMENT |
| POLYESTER | CHOPPED POLYESTER | 0.05-0.15 | 0.1 | THERMAL |
| STAPLE | YARN, 3 mm, 1.2 dtex | | | STABILIZER |

| | SUPPLIER & | |
|---|---|---|
| GENERIC | TRADE NAME | |
| INGREDIENT | OF TYPICAL | |
| NAME | GRADE | COMMENT |
| CSM | DU PONT: HYPALON | Excellent moisture resistance |
| | 40 | (elastomer commonly used in dam |
| CPE | DU PONT: TYRIN | linings). High green strength/high |
| TALC | SCOTIA TALC | filler acceptance. |
| S | DE GUSSA: SILANE Si | Inherent steel bonding |
| SILANE | 69 | characteristics. Good PVC |
| LIQUID CNBR | HYPRO: EMERALD | adhesion when compounded. |
| | MATERIALS | Excellent oxidation resistance. |
| CHLORINATED | DOVER CHEM: | Similar properties to CSM but at |
| POLYETHYLENE | CHLOROFLO | lower cost. |
| PALE LIQUID | NEVILLE CHEM: | Reduces cost. Low water |
| CIR | CUMAR P-10 | adsorption. Promotes reduction of |
| BKF | BAYER: | compound surface tension. |
| | VULKANOX BKF | Promotes filler/elastomer coupling |
| TMQ | BAYER: | & labile cross-link formation. |
| | VULKANOX DS | Improved high temperature flow |
| | | resistance. |
| C5 RESIN | EXXON: | Promotes substrate adhesion |
| | ESCOREX | Promotes substrate adhesion and |
| | 1102 | surface tack. |
| GUM ROSIN | ARIZONA CHEM: | Good compatibility with CSM. |
| | SYLVALITE | Effective reduction in compound |
| MICROLITH | BASF: | plasticity/surface tension. Good |
| BLUE | MICROLITH | hydrophobicity. |
| | BLUE 7080T | Improves effectiveness of |
| POLYESTER | BARNET:CHDA912(12) | secondary tackifiers & |
| STAPLE | | hydrophobicity, enables increased |
| POLYESTER | BARNET:CHDA912(3) | filler loadings, reduces surface tension, |
| STAPLE | | promotes surface wetting, improves |
| | | steel/PVC surface compatibility and |
| | | adhesion. Reduces compound |
| | | plasticity. |
| | | Induces no staining or discoloration. |
| | | Low extractability. |
| | | Induces no staining or discoloration. |
| | | Low extractability. |
| | | General purpose synthetic resin. |
| | | Improves surface tack. |
| | | Esterified wood rosin. Improves |
| | | surface wetting and promotes |
| | | steel/PVC adhesion. |
| | | Compounds are colour coded for |
| | | both identification during |
| | | manufacture and to differentiate |
| | | from competitor offerings. |
| | | Improves tensile reinforcement and |
| | | thermal stability |
| | | Improves thermal stability without |
| | | affecting steel adhesion. |

FEATURES: Polar functional groups lead to hydrogen bond formation with substrate. Chopped fibre tensile (longitudinal) reinforcement with ease of lateral extensibility, allowing ease of application. Self-healing. Thermally stable.

### Example 2

A CPT in accordance with the invention was made up to have a reinforced adhesive component composition as given in Table 2.

This CPT is suitable for high temperature applications, i.e. substrate temperatures in excess of 100° C.

TABLE 2

| | | PARTS PER HUNDRED | | |
|---|---|---|---|---|
| GENERIC | | OF RUBBER/ELASTOMER | | |
| INGREDIENT | | | PRE- | INGREDIENT |
| NAME | DESCRIPTION | RANGE | FERRED | FUNCTION |
| NBR | ACRYLONITRILE | 100 | 100 | ELASTOMER |
| | BUTADIENE | | | |
| | RUBBER | | | |
| TALC | MINERAL FILLER | 75-150 | 120 | HYDROPHOBIC |
| | | | | DILUENT FILLER |
| SILANE | THIO SILANE | 2.5-7.0 | 4.5 | ADHESION PROMOTER/ |
| | COUPLING | | | FILLER COUPLING |
| | AGENT | | | AGENT |
| CHDCE | CYCLO | 30-70 | 40 | POLYMERIC |
| | CARBOXYLIC | | | PLASTICISER |
| | ESTER | | | |
| PALE LIQUID | LIQUID | 40-80 | 75 | PLASTICIZER/ |
| CIR | COUMARONE | | | TACKIFIER |
| | INDENE RESIN | | | |
| BKF | SUBSTITUTED | 0.5-1.5 | 1.2 | NON-STAINING |
| | PHENOL | | | ANTIOXIDANT |
| | ANTIOXIDANT | | | |
| TMQ | SUBSTITUTED | 0.5-1.5 | 1.0 | NON-STAINING |
| | PHENOL | | | ANTIOXIDANT |
| | ANTIOXIDANT | | | |
| GUM ROSIN | ROSIN ESTER | 25-75 | 60 | TACKIFYING |
| | | | | RESIN |
| MICROLITH | PHTHALOCYANINE | 0.3-1.5 | 0.3 | COLOUR |
| BLUE | PIGMENT | | | MODIFIER |
| POLYESTER | CHOPPED POLYESTER | 0.7-1.5 | 0.9 | TENSILE |
| STAPLE | YARN, 6 mm, 1.2 dtex | | | REINFORCEMENT |
| CBS | ZINC OXIDE | 3.0-6.0 | 4 | CURING ACTIVATOR |
| | STEARIC ACID | 0.4-1.8 | 1 | CURING ACTIVATOR |
| | CYCLOHEXYL | | | |
| | BENZATHIAZOLE | 1.0-2.5 | 1.5 | VULCANIZATION |
| | SULPHENAMIDE | | | ACCELERATOR |
| TMT | TETRAMETHYL | 0.3-1.0 | 0.3 | VULCANIZATION |
| | THIURAM | | | ACCELERATOR |
| | DISULPHIDE | | | |
| DIMORPHOLENE | SULPHUR | 2.5-4.0 | 3.0 | CURING AGENT |
| | DONOR | | | |

| | SUPPLIER & | |
|---|---|---|
| GENERIC | TRADE NAME | |
| INGREDIENT | OF TYPICAL | |
| NAME | GRADE | COMMENT |
| NBR | BAYER: KRYNAC | General purpose, high |
| | 2745C | molecular weight, nitrile |
| | | rubber. High green strength. |
| TALC | SCOTIA TALC | High filler/additive loading |
| | | capacity. |
| SILANE | DE GUSSA: | Moderate cure rate at low |
| | SILANE Si 69 | cure-in-situ temperatures. |
| | | Reduces cost. Low water |
| | | adsorption. Low moisture |
| CHDCE | BASF: HEXAMOL | content. Promotes reduction of |
| | DINCH | compound surface tension. |
| | | Promotes filler/elastomer |
| PALE LIQUID | NEVILLE CHEM: | coupling & labile cross-link |
| CIR | CUMAR P-10 | formation. Improved high |
| | | temperature flow resistance. |
| BKF | BAYER: | Promotes substrate adhesion |
| | VULKANOX BKF | High permanence/low |
| | | extractability. Effective |
| TMQ | BAYER: | reduction in compound |
| | VULKANOX DS | plasticity/surface tension. |
| | | Good hydrophobicity. |
| GUM ROSIN | ARIZONA CHEM: | Improves effectiveness of |
| | SYLVALITE | secondary tackifiers & |
| MICROLITH | BASF: | hydrophobicity, enables |
| BLUE | MICROLITH | increased filler loadings, |
| | BLUE 7080T | reduces surface tension, |
| POLYESTER | BARNET:CHDA912(12) | promotes surface wetting, |
| STAPLE | | improves adhesion to PVC. |
| CBS | BAYER: | High permanence/low |
| | VULKACIT | extractability. Low toxicity. |
| | CZ | Induces no staining or |
| TMT | BAYER: | discoloration. Low |
| | VULCACIT | extractability. |
| | THIURAM | Induces no staining or |
| | | discoloration. Low |
| DIMORPHOLENE | MONSANTO: | extractability. |
| | SULPHASAN R | Esterified wood rosin. Good |
| | | NBR compatibility. Improves |
| | | surface wetting and promotes |
| | | PVC adhesion. |
| | | Compounds are colour coded |
| | | for both identification during |
| | | manufacture and to |
| | | differentiate from competitor |
| | | offerings. |
| | | Improves tensile reinforcement |
| | | and thermal stability |
| | | Zinc oxide/stearic acid used |
| | | commonly to boost cure state |
| | | in rubber compounds. |
| | | Long cure indiction/long shelf |
| | | life, increased vulcanization |
| | | rate. |
| | | Improved vulcanized compound |
| | | physical properties. No free |
| | | sulphur. Improved vulcanized |
| | | compound physical properties. |
| | | Extended pre-cured shelf life |

FEATURES: Elevated temperature applications. Vulcanizable, chemically bonded to steel via pre-applied, commercially available primer (rubber-to-metal bonding agent). Soft, tacky, conformable, easy to apply. Cures in situ.

### Example 3

A flexible wrapping tape for use in a kit in accordance with the invention was made up to have composition as given in Table 3.

This flexible wrapping tape is suitable for high temperature applications, i.e. substrate temperatures in excess of 100° C.

TABLE 3
VULCANISABLE, NITRILE RUBBER/PVC BASED SELF-FUSING COVER PLY
AND OUTER WRAP FOR USE AT ELEVATED TEMPERATURE (140 C).

| | | PARTS PER HUNDRED OF | | | SUPPLIER & | |
|---|---|---|---|---|---|---|
| GENERIC | | RUBBER/ELASTOMER | | | TRADE NAME | |
| INGREDIENT | | | PRE- | INGREDIENT | OF TYPICAL | |
| NAME | DESCRIPTION | RANGE | FERRED | FUNCTION | GRADE | COMMENT |
| NBR | NBR/PVC | 120-140 | 120 | ELASTOMER | POLYEUROPA: | NBR and PVC are compatible at |
| | PRE-BLEND | | | | N OZO 70.28 | a molecular level and can be |
| PVC | PVC RESIN | 0-20 | 5 | IMPACT | SASOL: PVC | blended in any ratio - effectively |
| | | | | MODIFIER | S7106 | forming a cross-linkable PVC. |
| TALC | MINERAL | 50-150 | 120 | HYDROPHOBIC | SCOTIA TALC | Improves impact resistance in |
| | FILLER | | | DILUENT FILLER | | physically demanding |
| SILANE | THIO SILANE | 0.5-2.5 | 0.7 | ADHESION | DE GUSSA: | environments. |
| | | | | PROMOTER/FILLER | SILANE Si 69 | Reduces cost. Low water |
| | | | | COUPLING AGENT | | adsorption. Low moisture |
| CHDCE | CYCLO | 30-70 | 20 | POLYMERIC | BASF: | content. Promotes reduction of |
| | CARBOXYLIC | | | PLASTICISER | HEXAMOL | compound surface tension. |
| | ESTER | | | | DINCH | Promotes filler/elastomer |
| PALE | LIQUID | 40-80 | 30 | PLASTICIZER/ | | coupling & labile cross-link |
| LIQUID | COUMARONE | | | TACKIFIER | | formation. Improved high |
| CIR | INDENE RESIN | | | | | temperature flow resistance. |
| BKF | SUBSTITUTED | 0.5-1.5 | 1.5 | NON-STAINING | BAYER: | Promotes substrate adhesion |
| | PHENOL | | | ANTIOXIDANT | VULKANOX | High permanence/low |
| | ANTIOXIDANT | | | | BKF | extractability. Effective reduction |
| TMQ | SUBSTITUTED | 0.5-1.5 | 1.5 | NON-STAINING | BAYER: | in compound plasticity/surface |
| | PHENOL | | | ANTIOXIDANT | VULKANOX | tension. Good hydrophobicity. |
| | ANTIOXIDANT | | | | DS | Improves effectiveness of |
| GUM ROSIN | ROSIN ESTER | 25-75 | 30 | TACKIFYING | ARIZONA | secondary tackifiers, enables |
| | | | | RESIN | CHEM: | increased filler loadings, reduces |
| | | | | | SYLVALITE | surface tension, |
| N550 | CARBON BLACK | 3.0-5.0 | 3 | UV | CORAX: N550 | promotes surface wetting, |
| | | | | STABILISER | | improves both self-fusion and |
| | ZINC OXIDE | 3.0-6.0 | 4 | CURING | | adhesion to PVC. High |
| | | | | ACTIVATOR | | permanence/low extractability. |
| | STEARIC ACID | 0.4-1.8 | 1 | CURING | | Low toxicity. |
| | CYCLOHEXYL | | | ACTIVATOR | | Induces no staining or |
| | BENZATHIAZOLE | | | | | discoloration. Low extractability. |
| CBS | SULPHENAMIDE | 1.0-2.5 | 1.5 | VULCANIZATION | BAYER: | Induces no staining or |
| | TETRAMETHYL | | | ACCELERATOR | VULKACIT | discoloration. Low extractability. |
| | | | | | CZ | Esterified wood rosin. Good NBR |
| TMT | THIURAM | 0.3-1.0 | 0.7 | VULCANIZATION | BAYER: | compatibility. Improves surface |
| | DISULPHIDE | | | ACCELERATOR | VULCACIT | wetting and promotes self-fusing |
| | | | | | THIURAM | and PVC adhesion. |
| DI- | SULPHUR | 2.5-4.0 | 3.0 | CURING AGENT | MONSANTO: | UV stability at elevated |
| MORPHOLENE | DONOR | | | | SULPHASAN R | temperature. |
| | | | | | | Zinc oxide/stearic acid used |
| | | | | | | commonly to boost cure state in |
| | | | | | | rubber compounds. |
| | | | | | | Long cure indiction/long shelf |
| | | | | | | life, increased vulcanization rate. |
| | | | | | | Improved vulcanized compound |
| | | | | | | physical properties. |
| | | | | | | No free sulphur. Improved |
| | | | | | | vulcanized compound physical |
| | | | | | | properties. Extended pre-cured |
| | | | | | | shelf life |

FEATURES: Elevated temperature applications. Vulcanizable, conformable, easy to apply. Self-fusing (ie not self-adhesive via PSA). Cures in situ.

### Example 4

A CPT comprising an adhesive layer having a composition as defined in Table 1 and a PVC backing layer was wound continuously around an exposed steel pipe section, forming an inner wrap. The CPT was provided with a removable release film, which was removed and discarded prior to wrapping.

A flexible outer armouring was also provided comprising a self-adhesive PVC film applied helically and under tension, with a 55% overlap, to yield at least a double layer of protection.

The adhesive properties and impact resistance of the CPT were measured with reference to ISO 21809-3:2016 (Petroleum and natural gas industries—External coatings for buried or submerged pipelines used in pipeline transportation systems—Part 3: Field joint coatings). The results are provided in Table 4.

TABLE 4
Adhesive and impact resistance properties of CPT in
accordance with the invention

| Analytical | | | | |
|---|---|---|---|---|
| Analysis | | | | CPT in accordance |
| Wrapping | | | | with the |
| System | Conditions | Unit | ISO21809-3 | invention |
| Thickness: | | μm | | Innerwrap (1x single |
| | | | | straight wrap) |
| | | | | Outerwrap (2 × 55% |
| | | | | overlap PVC HD) |
| Innerwrap | | | | 900 |
| compound | | | | |
| thickness | | | | |
| Total | | | | 3200 |
| system | | | | |
| thickness | | | | |
| Peel | @23° C. | N/mm | ≥0.2 | 0.45-Pass |
| Strength | @70° C. | N/mm | ≥0.02 | 0.07-Pass |
| Layer to | | | | |
| Layer | | | | |
| Outer to | | | | |
| Outer | | | | |
| Peel | @23° C. | N/mm | ≥0.04 | 0.32-Pass >95% |
| Strength to | | | Substrate | Coverage |
| pipe | | | Coverage | |
| surface | | | >95% | |
| | @70° C. | N/mm | ≥0.02 | 0.06-Pass >95% |
| | | | Substrate | Coverage |
| | | | Coverage | |
| | | | >95% | |
| Impact | @23° C. | J | ≥15 | Pass |
| Resistance | | | | (MAX 16J) |

The CPT of the present invention provides many advantages over conventional inner wrap constructions of CPTs as hereinbefore described. The advantages include
the use of PVC for both inner wrap backing and outer wrap improves mechanical protection and bagging resistance
self healing after puncturing induced from the PVC inner wrap backing alone, enhanced by the PVC outer wrap
very high adhesive values attainable with polar FME based mastic adhesives to both PVC and steel prevents moisture ingress at any interface
easy release of the aggressive adhesive component from release films
use of high MW FME improves adhesive component green strength and adhesion peel resistance. High MW also provides resilient recoverability after thermal stressing and resistance to flow and creep
availability of Van der Waals and hydrogen bonds provides additional adhesion promotion and allows for minimum surface preparation
use of CSF reinforcement provides flow and creep resistance at elevated temperature. CSF inclusion also eliminates the possibility of delamination, or flow/creep at the adhesive component/reinforcing carrier interface
asymmetric reinforcement due to alignment of CSF allows ease of lateral (and slight longitudinal) stretching to facilitate ease of application.

The CPT of the invention, as hereinbefore set out, provides good adhesion and surface wetting.

When a liquid spreads onto a solid surface, an adhesive bond is formed between the substances. The strength of the bond, which is only established when liquid and solid are in very close proximity, is dependent on the mutual compatibility of the components and their relative surface tension. Water droplets form distinct beads on the surface of wax-polished paintwork as a result of the high surface tension in the water and the hydrophobicity of the wax polish. Adding soap to the water droplet lowers the surface tension and allows the droplet to spread over, or ‘wet’, the polished surface. The adhesive bond formed between a liquid and wetted surfaces are termed Van der Waal forces and such bonds, which may be relatively strong, form the basis of many adhesive systems.

The adhesive component of the CPT of the invention is in the form of a very soft, conformable mass, which readily flows into, and wets, the micro fissures of the steel surface. Aggressive adhesion between the adhesive and substrate is vital in order to resist the ingress of moisture at the adhesive component/steel interface. The tenacity with which the adhesive bonds to the substrate is also important, since even after mechanical impact, sufficient adhesive residue must remain adhered to the steel surface to prevent moisture incursion and the possible onset of corrosion. Traditional adhesive components rely solely on the good surface wetting of the substrate and the subsequent Van der Waal bond formation between the adherents. Viewed chemically, the adhesive component must bond to iron oxide, since iron, in steel, is spontaneously oxidised when exposed to the oxygen in the atmosphere. The FME is able to form hydrogen bonds with the polar, oxygenate surface.

Adhesive bond formation is also crucial to both the backing layer and the tensile reinforcing strands of the CPT. The adhesive body of the CPT of the invention is formulated to provide good adhesion to the other tape components (reinforcing fibres and PVC backing film) and the resultant structure forms a composite with optimized performance.

The invention thus uses the novel combination of FMEs, CSFs and PVC film as the components of a CPT which, together with its over wrapping, provides a mechanically protective system. Polar FMEs promote surface chemistry induced benefits when used to replace the bitumen, petrolatum or polyisobutylene (PIB) adhesive component of CPTs currently available. Reinforcing of the adhesive component with CSFs and backing with a PVC film, provides a composite structure whose improved physical characteristics overcome many of the limitations of CPTs currently commercially available. The CPT constructions described in this patent are applicable to the requirements of standard EN12068 Class C.

The construction of the CPT in accordance with the invention uses components which have been specifically designed to have high adhesive strength to both themselves and with the substrate (typically steel) to which the CPT is applied. Such a construction leads to the formation of a composite CPT structure, resulting in improved performance over traditionally applied tapes.

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents.

1. A corrosion prevention tape for wrapping an irregular pipe section, the tape comprising:
(i) an adhesive component, the adhesive component comprising:
from 10 to 50 wt % functionally modified elastomer, and
from 0.1 to 20 wt % discrete reinforcing strands dispersed within the adhesive component; and
(ii) a backing layer for the adhesive component.

2. The corrosion prevention tape according to claim 1, wherein the functionally modified elastomer (FME) comprises an elastomeric backbone including a plurality of side chains bearing at least one polar functional group,
preferably wherein the at least one polar functional group is selected from the group consisting of a carboxylic acid, chloro, chlorosulfanyl, epoxy, nitrile, sulphide and mixtures of two or more thereof.

3. The corrosion prevention tape according to claim 2, wherein the FME is selected from the group consisting of an acrylic polymer, a carboxylic polymer, polychloroprene, chlorinated polyethylene, a chlorosulphanyl polymer, a epichlorohydrin polymer, an ethylene acrylic copolymer, isobutylene-paramethylstyrene copolymer, a nitrile polymer, a blend of PVC and a nitrile polymer, polysulphide polymer, a styrene butadiene copolymer, and mixtures of two or more thereof.

4. The corrosion prevention tape according to claim 2, wherein the FME is selected from
a) carboxylic polymer
b) chlorinated polyethylene
c) chlorosulphonated polyethylene
d) polychloroprene
e) nitrile polymer
f) a blend of a nitrile polymer and PVC,
and mixtures thereof.

5. The corrosion prevention tape according to claim 1, wherein the discrete reinforcing strands have a length of from 2 to 8 mm.

6. The corrosion prevention tape according to claim 5, wherein the discrete reinforcing strands include strands having a length of from 2 to 4 mm and strands having a length of from 5 to 8 mm, wherein the strands having a length of from 2 to 4 mm and the strands having a length of from 5 to 8 mm are present in a weight ratio of from 1:5 to 1:50, more preferably from 1:10 to 1:40.

7. The corrosion prevention tape according to claim 1, wherein the discrete reinforcing strands are chopped synthetic textile fibre strands, preferably wherein the chopped synthetic textile fibre strands are polyester strands.

8. The corrosion prevention tape according to claim 1, wherein the adhesive component further comprises:
from 25 to 70 wt % mineral filler; and/or
from 0.05 to 2.5 wt % adhesion promoter; and/or
from 5 to 40 wt % plasticizer; and/or
from 5 to 30 wt % tackifying resin.

9. The corrosion prevention tape according to claim 8, wherein:
the mineral filler is selected from the group consisting of a clay-based mineral filler, a magnesium silicate-based mineral filler, and mixtures of two or more thereof; and/or
the adhesion promoter is a thiosilane and/or a liquid carboxylated nitrile butadiene rubber; and/or
the plasticizer is selected from the group consisting of chlorinated paraffin, organo phosphates or phthalates, aromatic hydrocarbons and mixtures of two or more thereof; and/or
the tackifying resin is selected from the group consisting of a hydrocarbon tackifying resin, a phenolic tackifying resin, a rosin ester, a liquid coumarone resin and mixtures of two or more thereof.

10. The corrosion prevention tape according to claim 1, wherein the adhesive component comprises, expressed as parts by mass per hundred parts by mass elastomer, the following:

| | Range |
|---|---|
| FME | 100 |
| filler | 75-150 |
| plasticiser | 70-150 |
| tackifying resin | 50-125 |
| other additives | 1-7 |

11. The corrosion prevention tape according to claim 10, wherein the adhesive component comprises, expressed as parts by mass per hundred parts by mass elastomer, the following:

| | Range |
|---|---|
| first FME | 70-100 |
| second FME | 0-30 |
| mineral filler | 75-150 |
| first plasticiser | 30-70 |
| second plasticiser | 40-80 |
| first tackifying resin | 25-50 |
| second tackifying resin | 25-75 |
| adhesion promoter | 2.5-7.0 |
| first antioxidant | 0.5-1.5 |
| second antioxidant | 0.5-1.5 |
| colour modifier | 0.3-1.5 |

12. The corrosion prevention tape according to claim 1, wherein the composition forming the backing layer comprises polyvinyl chloride.

13. The corrosion prevention tape according to claim 1, which includes a release film covering the side of the adhesive component remote from the backing layer, preferably wherein the composition forming the release film comprises a non-polar material.

14. The corrosion prevention tape according to claim 1, wherein the adhesive component is vulcanizable,
preferably wherein the adhesive component further comprises a curing system which permits vulcanization of the adhesive component,
more preferably wherein the curing system comprises one or more of the following: a curing activator, a vulcanization accelerator, and a curing agent.

15. The corrosion prevention tape according to claim 1, wherein the tape is functional at a continuous operating temperature of up to 130° C.

16. A kit for providing a pipe joint with corrosion protection, the kit comprising the corrosion prevention tape according to claim 1 and a flexible wrapping tape.

17. The kit according to claim 16, wherein the composition forming the flexible wrapping tape comprises a vulcanizable rubber.

18. The kit according to claim 17, wherein the composition forming the flexible wrapping tape further comprises a curing system which permits vulcanization of the vulcanizable rubber,
preferably wherein the curing system comprises one or more of the following: a curing activator, a vulcanization accelerator, and a curing agent.

19. A corrosion protected article, which includes a substrate, preferably a steel pipe section, covered by a corrosion prevention tape, with at least a portion of the adhesive component of the corrosion prevention tape adhering to the substrate,
preferably wherein the article is further provided with a flexible wrapping tape as defined in claim 16 provided on the corrosion prevention tape.

20. A method of protecting a substrate, preferably a steel pipe section, against corrosion, the method comprising wrapping the substrate with a corrosion prevention tape such that at least a portion of the adhesive component of the corrosion prevention tape adheres to the substrate and, optionally, binding the corrosion prevention tape with a flexible wrapping tape as defined in claim 16.
